(19) United States
(12) Patent Application Publication
(10) Pub. No.: US 2026/0133955 A1
(43) Pub. Date: May 14, 2026

(54) MONITORING AND VISUALIZING CONSISTENCY BETWEEN OFFCHAIN AND ONCHAIN ASSETS

(71) Applicant: Unstoppable Domains, Inc., Las Vegas, NV (US)

(72) Inventors: Lisa Seacat DeLuca, Bozeman, MT (US); Matthew Gould, Atlanta, GA (US); Thomas Frederic Irish, Rockville, MD (US)

(21) Appl. No.: 18/941,330

(22) Filed: Nov. 8, 2024

(51) Int. Cl. G06F 16/23; G06F 9/54; G06F 16/26

(52) U.S. Cl. CPC G06F 16/2365; G06F 9/542; G06F 16/26

(57) ABSTRACT

According to a present invention embodiment, a computer system for managing assets of a computer environment comprises one or more memories and at least one processor coupled to the one or more memories. The system detects occurrence of an event for a first asset of the computer environment on a centralized system. The first asset on the centralized system corresponds to a second asset of the computer environment on a decentralized system. Consistency between the first asset and the second asset is determined based on the event. The consistency between the first asset and the second asset is visualized for the second asset on a user interface. Embodiments of the present invention further include a method and computer program product for managing assets of a computer environment in substantially the same manner described above.

### TECHNICAL FIELD

Present invention embodiments relate to networking and, more specifically, to monitoring and visualizing consistency between an offchain asset (e.g., Web2 domains or domain names, Internet Corporation for Assigned Names and Numbers (ICANN) domains or domain names, Domain Name System (DNS) domains or domain names, assets of other centralized domain systems, etc.) and a corresponding onchain asset (e.g., non-fungible tokens (NFTs), blockchain domains or domain names, etc.) and controlling actions based on the consistency.

### BACKGROUND

### Discussion of the Related Art

There exists a trend to bridge worlds of real assets, such as physical and digital goods, with blockchain technology. For example, a non-fungible token (NFT) of a blockchain is a crypto type asset with each token being unique. An NFT may represent items, such as digital art, music, or video game items, and may also represent real assets (e.g., physical goods, tickets, etc.). A transfer of ownership of the NFT may be used to indicate transfer of ownership of the corresponding real asset.

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks.

A user may desire to obtain a Web2 domain and a corresponding Web3 domain (represented by a non-fungible token (NFT)). However, ownership of Web2 and Web3 domains are separable. In other words, transfer of one of the domains does not necessarily transfer ownership of the other domain which may provide operational and other inconsistencies.

### SUMMARY

According to one embodiment of the present invention, a computer system for managing assets of a computer environment comprises one or more memories and at least one processor coupled to the one or more memories. The system detects occurrence of an event for a first asset of the computer environment on a centralized system. The first asset on the centralized system corresponds to a second asset of the computer environment on a decentralized system. Consistency between the first asset and the second asset is determined based on the event. The consistency between the first asset and the second asset is visualized for the second asset on a user interface. Embodiments of the present invention further include a method and computer program product (e.g., including one or more computer readable media with instructions executable by one or more processors) for managing assets of a computer environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of registering a name or other identifier for an onchain asset (e.g., Web3, blockchain, etc.) based on a name or other identifier for an offchain asset (e.g., Web2, Domain Name System (DNS), etc.) and assigning a managing entity for the offchain and onchain assets within the onchain asset according to an embodiment of the present invention.

FIG. 4 is a flowchart of a method of transferring an offchain asset according to an embodiment of the present invention.

FIG. 5 is a flowchart of a method of controlling actions for offchain and onchain assets based on assignment of a managing entity within the onchain asset according to an embodiment of the present invention.

FIG. 6 is a flowchart of a method for monitoring and visualizing consistency between corresponding offchain and onchain assets according to an embodiment of the present invention.

FIG. 7 is a schematic illustration of an example graphical user interface indicating a domain with corresponding registrar and consistency information according to an embodiment of the present invention.

FIG. 8 is a schematic illustration of an example graphical user interface presenting domains with corresponding certifications, registrars, and visualizations indicating consistency according to an embodiment of the present invention.

### DETAILED DESCRIPTION

There exists a trend to bridge worlds of real assets, such as physical and digital goods, with blockchain technology. For example, a non-fungible token (NFT) of a blockchain is a crypto type asset with each token being unique. An NFT may represent items, such as digital art, music, or video game items, and may also represent real assets (e.g., physical goods, tickets, etc.). A transfer of ownership of the NFT may be used to indicate transfer of ownership of the corresponding real asset.

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

In contrast, Web3 generally refers to a decentralized version of the web (or Internet) based on blockchains and peer-to-peer networks.

In order to to bridge the gap between Web2 and Web3, an embodiment of the present invention enables an offchain (e.g., Web2, etc.) domain name to be tokenized so that there is an onchain representation. For example, a non-fungible token (NFT) may be created on a blockchain representing the offchain domain name. This enables a user who also owns the offchain domain name to send and receive digital assets to that domain name (e.g., tokens or cryptocurrencies) and be able to leverage the benefits of Web3 technology, such as fast digital asset transfer and proof of ownership.

However, the user may obtain a tokenized (or onchain) version of an offchain domain name, and the offchain version of the domain name may not be transferred to the new owner or may be disabled (e.g., due to trademark infringement, illegal or scam content, etc.). In this case, it may be difficult to provide a refund or otherwise determine ownership of both the tokenized (onchain) and the offchain domain.

Further, unless a registrar or other managing entity controls both an onchain and offchain state of an asset (e.g., domain name, etc.), the correspondence between an offchain asset and its onchain equivalent may be severed which may provide operational and other inconsistencies. By way of example, a change in the registrar for an offchain asset may sever the correspondence with an onchain asset. There are multiple reasons for a user to change the registrar for an offchain asset (e.g., cost, customer service, ease of use, additional services, reliability and stability, better domain management, privacy concerns, contract or policy changes, consolidation, etc.). For example, a registrar that offers better pricing or promotional deals may reduce costs for offchain domain registration and renewal fees. Poor customer service may initiate a registrar change, especially when experiencing issues, such as long wait times, unhelpful responses, or difficulty resolving issues. Registrars with user-friendly interfaces and management tools for ease of use may also be attractive. Further, different registrars may offer desired additional services, such as website hosting, email hosting, security features, or website builders. Frequent downtime or technical issues impacting offchain domain management may provoke a change to a more reliable registrar. Moreover, some registrars may offer advanced offchain domain management tools to streamline workflow, privacy protections, and/or more favorable terms. In addition, consolidation of offchain domains registered with multiple registrars may also provoke a registrar change.

Accordingly, an embodiment of the present invention visualizes consistency between an offchain asset (e.g., Web2 domains or domain names, ICANN domains or domain names, Domain Name System (DNS) domains or domain names, assets of other centralized domain systems, etc.) and a corresponding an onchain (or tokenized) asset to provide transparency onchain about the consistency of the offchain asset via non-fungible token (NFT) metadata. Consistency between the offchain and onchain assets may indicate whether or not the offchain and onchain assets are consistent or inconsistent with respect to each other. The consistency may be based on any quantity of any attributes (e.g., operational, compliance, property, etc.) of the offchain and onchain assets. For example, offchain and onchain assets may be considered consistent when attributes are the same or the offchain and/or onchain asset are compliant, such as when the ownership or other rights in the offchain and onchain assets are the same, the same entities own or have other rights in the offchain and onchain assets, the offchain and/or onchain asset comply with requirements, and/or the offchain and/or onchain asset are enabled. By way of further example, the offchain and onchain assets may be considered inconsistent when a discrepancy exists (e.g., attributes are different or the offchain and/or onchain asset are non-compliant), such as a difference in ownership or other rights in the offchain and onchain assets, a difference in entities owning or having other rights in the offchain and onchain assets, the offchain and/or onchain asset fail to comply with requirements, the offchain and/or onchain asset are disabled, and/or incomplete, old, and/or incorrect contact or other information for the offchain and/or onchain asset.

An embodiment of the present invention maintains the correspondence between offchain and onchain assets and controls actions to be performed for the offchain assets (e.g., Web2 domains or domain names, ICANN domains or domain names, Domain Name System (DNS) domains or domain names, assets of other centralized domain systems, etc.) and the onchain assets (e.g., non-fungible tokens (NFTs), blockchain domains or domain names, etc.) based on assignment of managing entities (e.g., custodians, registrars, users, etc.) within the onchain assets. Thus, when a change occurs to an onchain or offchain version of an asset (e.g., a change of state, a change of registrar, a transfer to a new owner, etc.), the embodiment mirrors the change to the other version to maintain correspondence and control between the onchain and offchain versions. This may be accomplished by providing a managing entity with control and access to perform the changes. Further, when a discrepancy arises between an offchain and onchain asset (e.g., the offchain and/or onchain asset becomes non-compliant, different ownership between onchain and offchain assets, compliance requirements for the offchain asset are not satisfied, etc.), an indicator or other visualization is provided for the onchain asset to indicate the discrepancy and actions for the onchain asset may be controlled (e.g., preventing transfer of the onchain asset, etc.). For example, a compliance requirement of an authority (e.g., ICANN, etc.) may include updating contact information for an offchain version of a domain name to reflect a current owner. When the contact information is not updated for a new owner of the offchain version, a visualization for this discrepancy may be provided for the onchain version to notify a user of the discrepancy. Moreover, transfer of the onchain and/or offchain asset may be prevented.

By way of example, an onchain asset may be a non-fungible token (NFT) representing a corresponding onchain version of an offchain domain name (or tokenized version of the offchain domain name). An offchain domain name may be tokenized as an NFT or other onchain representation by a blockchain service or smart contract. In other words, an embodiment of the present invention provides an authority to oversee a tokenized version of an offchain domain, and leverages features of onchain domains (e.g., wallet signatures, etc.) to verify and enable a managing entity to perform actions for the offchain and onchain domains (e.g., switch managing entities for the offchain domain, renew offchain and/or onchain assets, mint NFTs (or tokenize) the offchain asset, etc.) to maintain correspondence. Further, the embodiment of the present invention may enable use of authorization codes in the onchain domain to verify and enable a managing entity to perform actions for the offchain and/or onchain domains (e.g., change managing entities for the offchain domain, renew offchain and/or onchain assets, mint NFTs (or tokenize) the offchain asset, etc.). In addition, the embodiment of the present invention provides a visualization to indicate to users when there is a discrepancy between onchain and offchain versions of a domain or asset (thereby producing a disconnect or severance between the onchain and offchain versions).

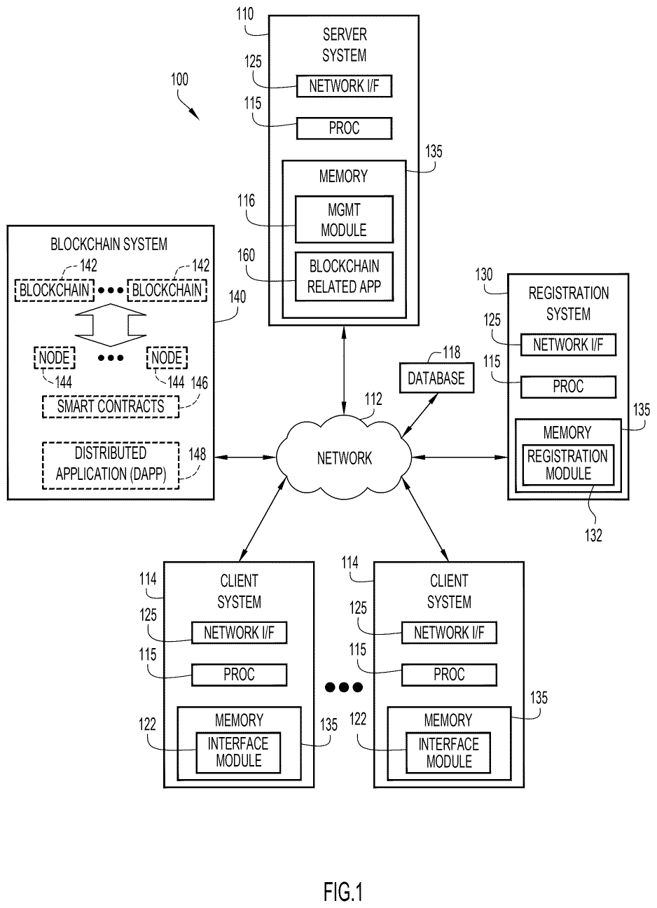

An example environment 100 for use with present invention embodiments is illustrated in FIG. 1. Specifically, environment 100 includes one or more server systems 110, one or more client or end-user systems 114, one or more registration systems 130, and one or more blockchain systems 140 each implementing and maintaining at least one corresponding blockchain 142. Server systems 110, client systems 114, registration systems 130, and/or blockchain systems 140 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform onchain and/or offchain asset management (e.g., for domains or other objects, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110, registration systems 130, and blockchain systems 140 for managing onchain and/or offchain assets (e.g., domains or other objects, etc.). The interface module may include any conventional or other browser to access server systems 110, registration systems 130, and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). Registration systems 130 may each be associated with a corresponding managing entity (e.g., registrar, custodian, registry, etc.), or two or more different managing entities. By way of example, the registration system may include a conventional or other DNS server.

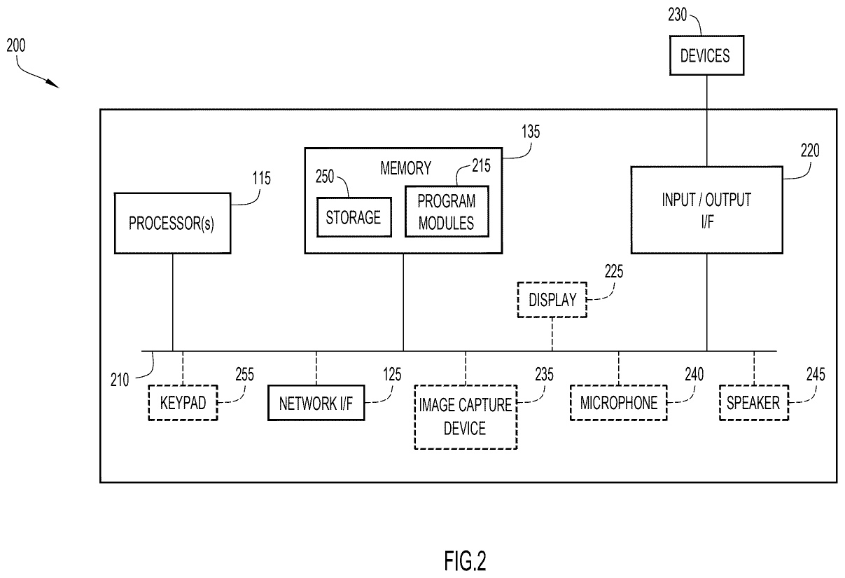

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 146) that executes on the blockchain in response to occurrence of pre-defined conditions. The smart contracts may authorize actions by a managing entity for onchain and/or offchain assets and transfer onchain and/or offchain assets between registrars as described below. The onchain assets may be associated with the same and/or various different blockchains.

Interface module 122 of client systems 114 may further provide a graphical user (e.g., GUI, etc.) or other interface (e.g., command line prompts, menu screens, etc.) that enables users to access decentralized applications (dApps) 148 and/or smart contracts 146 on blockchain systems 140 for performing various operations (e.g., financial or other transactions or operations related to a blockchain, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a transaction, transfers of onchain and/or offchain assets, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or offchain storage system 118 may store various information for a blockchain asset (e.g., blockchain asset information, managing entity information, mappings of blockchain assets to blockchains, blockchain domain content, etc.). The database system may be implemented by any conventional or other database or offchain storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, and registration systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 146, decentralized applications (dApps) 148, and blockchain related applications 160 may include one or more modules or units to perform the various functions of present invention embodiments described below. The various modules (e.g., management module 116, interface module 122, registration module 132, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., smart contracts 146, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., smart contracts 146, decentralized applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 146) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention leverages onchain assets (e.g., Web3 domains or domain names, blockchain domains or domain names, non-fungible tokens (NFTs), etc.) in order to control actions for offchain assets (e.g., Web2 domains or domain names, ICANN domains or domain names, Domain Name System (DNS) domains or domain names, etc.). For example, an action for an offchain asset (e.g., Web2 domain or domain name, ICANN domain or domain name, Domain Name System (DNS) domain or domain name, etc.) or onchain asset (e.g., Web3 domain or domain name, blockchain domain or domain name, non-fungible token (NFT), etc.) may be controlled based on a managing entity (e.g., registrar, custodian, registry, etc.) assigned within the onchain asset, thereby enabling the onchain asset to authorize actions for the offchain and/or onchain asset to maintain correspondence.

Further, when a discrepancy arises between offchain and onchain assets (e.g., an offchain and/or onchain asset becomes non-compliant, different ownership between onchain and offchain assets, compliance requirements for the offchain asset are not satisfied, etc.), an indicator or other visualization is provided for the onchain asset to indicate the discrepancy and actions for the onchain asset may be controlled (e.g., preventing transfer of the onchain asset, etc.). For example, a compliance requirement of an authority (e.g., ICANN, etc.) may include updating contact information for an offchain version of a domain name to reflect a current owner. When the contact information is not updated for a new owner of the offchain version, a visualization for this discrepancy may be provided for the onchain version to notify a user of the discrepancy. Moreover, transfer of the offchain and/or onchain asset may be prevented.

Transfer of an onchain or offchain asset may include any action or transaction that provides ownership or other rights, registration, and/or any other interest in the onchain or offchain asset. Further, acquiring or obtaining an onchain or offchain asset may include obtaining ownership or other rights, registration, and/or any other interest in the onchain or offchain asset. Moreover, a managing entity may include any entity controlling (e.g., registering, minting, tokenizing, managing, setting, updating, creating, maintaining, etc.) any operations, information, and/or aspects (e.g., states, properties, transfers, acquisitions, ownership, etc.) for an offchain and/or onchain asset (e.g., registrar, registry, custodian, user, domain owner, etc.).

Consistency between the offchain and onchain assets may indicate whether or not the offchain and onchain assets are consistent or inconsistent with respect to each other. The consistency may be based on any quantity of any attributes (e.g., operational, compliance, property, etc.) of the offchain and onchain assets. For example, offchain and onchain assets may be considered consistent when attributes are the same or the offchain and/or onchain asset are compliant, such as when the ownership or other rights in the offchain and onchain assets are the same, the same entities own or have other rights in the offchain and onchain assets, the offchain and/or onchain asset comply with requirements, and/or the offchain and/or onchain asset are enabled. By way of further example, the offchain and onchain assets may be considered inconsistent when a discrepancy exists (e.g., attributes are different or the offchain and/or onchain asset are non-compliant), such as a difference in ownership or other rights in the offchain and onchain assets, a difference in entities owning or having other rights in the offchain and onchain assets, the offchain and/or onchain asset fail to comply with requirements, the offchain and/or onchain asset are disabled, and/or incomplete, old, and/or incorrect contact or other information for the offchain and/or onchain asset.

In addition, a visualization may include any visual object, effect, and/or symbol to indicate consistency (consistent or inconsistent) between the offchain and onchain assets (e.g., any symbol, bold, underline, flash, font, size, color-coding, shading, border, etc.).

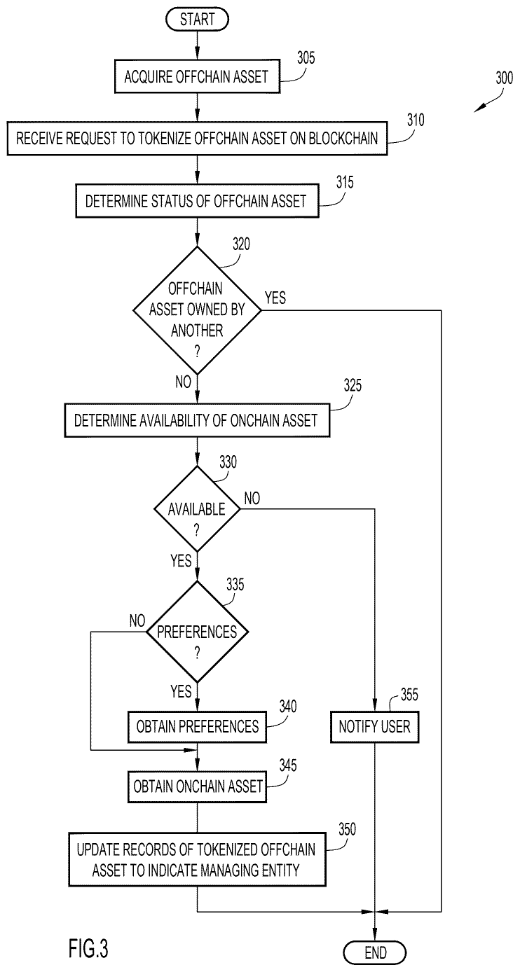

A method 300 of registering a name or other identifier for an onchain asset (e.g., Web3, blockchain, etc.) based on a name or other identifier for an offchain asset (e.g., Web2, Domain Name System (DNS), etc.) and assigning a managing entity for the offchain and onchain assets within the onchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 3. Initially, a user acquires a name or other identifier of an offchain asset (e.g., Web2, ICANN, Domain Name System (DNS), etc.) via any conventional or other techniques from a managing entity (e.g., registrar, registry, a prior owner, etc.) at operation 305. For example, management module 116 may acquire (e.g., via purchase, registration, transfer, etc.) an offchain asset (e.g., Web2 domain or domain name, ICANN domain or domain name, Domain Name System (DNS) domain or domain name, etc.) from a registrar via registration module 132 of a registration system 130 associated with the registrar. The management module may receive and process requests for the offchain asset from any entities (e.g., user, application, service, computing or other device, client system 114, etc.).

By way of example, the management module requests information (e.g., DNS records, etc.) for the offchain domain from registration system 130. The information from the registration system indicates registration/ownership or availability of the offchain domain. Once availability of the offchain domain is confirmed, management module 116 (e.g., via registration module 132 and registration system 130) may set or update an ownership record of the offchain domain. For example, DNS records for the offchain domain may be modified to indicate a new interest or ownership by a user. Management module 116 may present a user interface on a client system 114 to obtain information (e.g., contact information, etc.) for updating the records from the user. The information is provided to registration system 130 for updating records of the offchain domain.

The user may register the name or other identifier of the offchain asset (e.g., Web2, ICANN, Domain Name System (DNS), etc.) for an onchain asset (e.g., Web3, blockchain, non-fungible token (NFT), etc.) via management module 116 and authorize actions by a managing entity for the offchain and/or onchain assets. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), system other than a decentralized system described above, etc.). The name or other identifier for the offchain and onchain assets may include a name portion and an optional extension (e.g., “name e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.). A managing entity may include any entity controlling (e.g., registering, minting, tokenizing, managing, setting, updating, creating, maintaining, etc.) any operations, information, and/or aspects (e.g., states, properties, transfers, acquisitions, ownership, etc.) for an offchain and/or onchain asset (e.g., registrar, registry, custodian, user, domain owner, etc.).

Management module 116 receives a request for the name or other identifier of the offchain asset to tokenize (or create a corresponding non-fungible token (NFT) for) the offchain asset on a blockchain at operation 310. The management module may receive and process requests from any entities (e.g., user, application, service, computing or other device, client system 114, etc.). The management module performs a look-up of the name of the offchain asset at operation 315 to determine registration/ownership of the offchain asset by another user (e.g., indicating unavailability of the offchain asset). By way of example, the offchain asset may include an offchain domain name (e.g., Web2, Domain Name System (DNS), etc.), and management module 116 requests information (e.g., DNS records, etc.) for the offchain domain name from registration system 130. The information from the registration system indicates registration/ownership or availability of the offchain asset. When the offchain asset is registered/owned by another user as determined at operation 320, the onchain asset is not acquired and the process terminates.

When the offchain asset is registered/owned by the user as determined at operation 320, management module 116 determines availability of the name of the offchain asset for an onchain asset at operation 325. In other words, management module determines availability of an onchain equivalent of the offchain asset. For example, the management module (e.g., via blockchain related application 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, management module 116 may perform a look-up for the name (e.g., on a blockchain, marketplace, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 330, payment and other preferences may be provided or selected for acquiring the onchain version (e.g., tokenizing the offchain asset on the blockchain). The options or preferences may include payment to acquire the onchain representation, an intended blockchain or other system to publish or mint the onchain version, a smart contract for the transaction, etc. When preferences are required as determined at operation 335, management module 116 obtains the preferences at operation 340. The preferences may be stored offchain in database system 118, or received from an administrator.

The name for the onchain version is acquired at operation 345. For example, management module 116 (e.g., via blockchain related application 160, corresponding smart contract 146, and/or decentralized application (dApp) 148) publishes or creates (mints) the name for the onchain version (e.g., represented by a non-fungible token (NFT)) on a corresponding blockchain, and/or transfers the onchain asset from a current owner to the user (e.g., places the onchain asset in a user wallet account). The acquisition of the onchain version may be performed based on any required preferences. This may be accomplished by management module 116 (e.g., via blockchain related application 160, corresponding smart contract 146, and/or decentralized application (dApp) 148) providing a transaction to the blockchain indicating acquisition of the onchain version (or NFT) by the user. In addition, various information for the onchain version (e.g., user information, asset information, wallet information, information for a managing entity of the onchain and/or offchain asset, etc.) may be stored onchain and/or in offchain storage (e.g., database system 118, etc.).

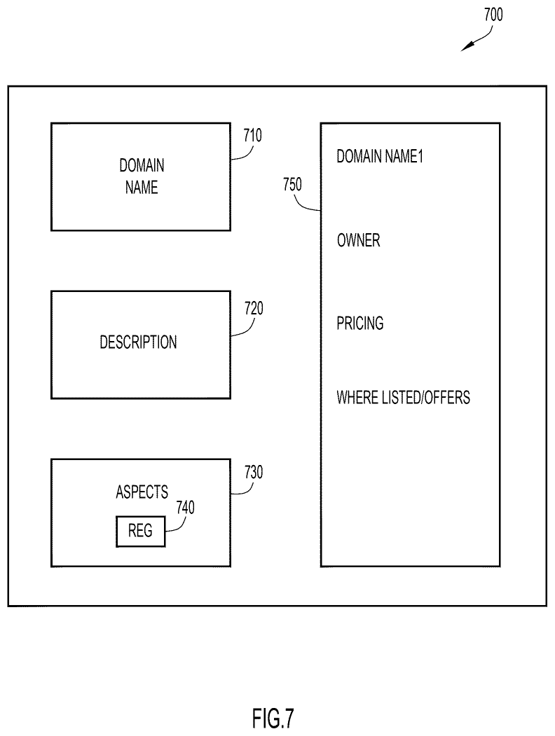

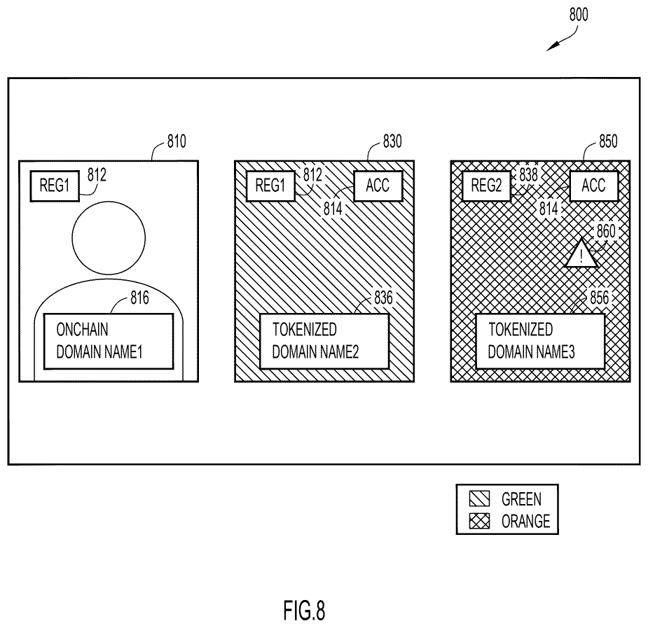

By way of example, the offchain asset or domain may be tokenized or minted via a registrar or other managing entity that has been approved into the onchain system (e.g., an ICANN accredited registrar, etc.). When a registrar or other managing entity tokenizes or mints an offchain asset or domain on a blockchain, the registrar or other managing entity is essentially guaranteeing that the registrar holds the offchain asset in custody. A registrar signature or proof may be recorded indicating which registry triggered minting of a particular offchain asset. Management module 116 (e.g., via decentralized application (dApp) 148 and/or blockchain related application 160) may set or update records associated with the onchain asset to indicate registrar or other managing entity information for the offchain asset at operation 350. For example, metadata for the onchain asset may be created or modified to include registrar or other managing entity information for the offchain asset (e.g., a name of the registrar or other managing entity, a wallet address of the registrar or other managing entity, an onchain or offchain domain name for the registrar or other managing entity, etc.). The metadata for the onchain asset may be stored on the blockchain and/or in offchain storage (e.g., database system 118, etc.). Further, a record may be created or modified to include the registrar or other managing entity information for the offchain asset. The record may be associated with, or accessible by, a smart contract 146 to perform various actions as described below. The metadata, record, or another record (e.g., an onchain or offchain record related to the metadata or record, etc.) may include for the registrar or other managing entity information a timestamp of receipt, reception, and/or expiration of the offchain asset, and/or an order or transaction record for the acquisition of the offchain asset as proof of ownership. A user interface may present visual indicators of the registrar, registrar certifications, and/or offchain asset consistency as described below (FIGS. 7 and 8).

Moreover, a custodian code may be used to grant access to the registrar or other managing entity indicated in the registrar information for the onchain asset. The custodian code is unique to each offchain asset or domain name, and typically provided by a registrar at registration. The custodian code serves as proof of identity and authorizes various actions to be performed by the registrar or other managing entity for the offchain and/or onchain assets (e.g., transfer, access to domain records, etc.). The custodian code may be stored with the registrar or other managing entity information and is preferably encoded for security. For example, the custodian code may include a nonce style random code, and/or a real static code (e.g., a proof of authenticity identifier, etc.) encoded by a hash-based message authentication (HMAC) using a unique (off-chain) secret (or key).

As a custodian of a domain, the registrar or other managing entity maintains the ability to perform compliance obligations (e.g., ICANN compliance obligations, etc.) including performing a takedown request, adjusting expiration dates, changing status of assets (e.g., valid, invalid, locked, etc.), setting itself as the custodian (with a custodial code) when the asset belongs to another custodian where a new custodial code is generated, set another managing entity as the custodian (when the asset belongs to the registrar), etc. as described below. The custodial code should be accessible and can be used as a mechanism to verify ownership to facilitate inter-registrar transfers directly onchain.

In addition, the offchain and onchain versions may be linked based on the name or other identifier. For example, management module 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

Further, management module 116 (e.g., via decentralized application (dApp) 148 and/or blockchain related application 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are acquired, transactions may be conducted (e.g., via management module 116 and/or blockchain related application 160) using the names for the onchain or offchain assets. For example, the information in the records for the offchain domain may be used to resolve data for the onchain representation (e.g., a user may send cryptocurrency to an offchain domain (based on an associated record indicating the onchain domain), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

The onchain asset (e.g., non-fungible token (NFT) representing the tokenized domain name) may serve to authorize the managing entity to perform actions on the offchain asset and/or onchain asset (e.g., without explicit consent from a user) as described below.

When the onchain asset is not available based on the look-up (e.g., an onchain representation of the offchain asset is already owned by the user or by another user that is not making the onchain asset available for transfer) as determined at operations 330, management module 116 alerts or notifies the user at operation 355. The notification may indicate ownership information for the onchain version of the offchain asset (e.g., the user or other user owning the onchain asset, etc.), and may be presented on a client system 114 (e.g., via interface module 122, etc.).

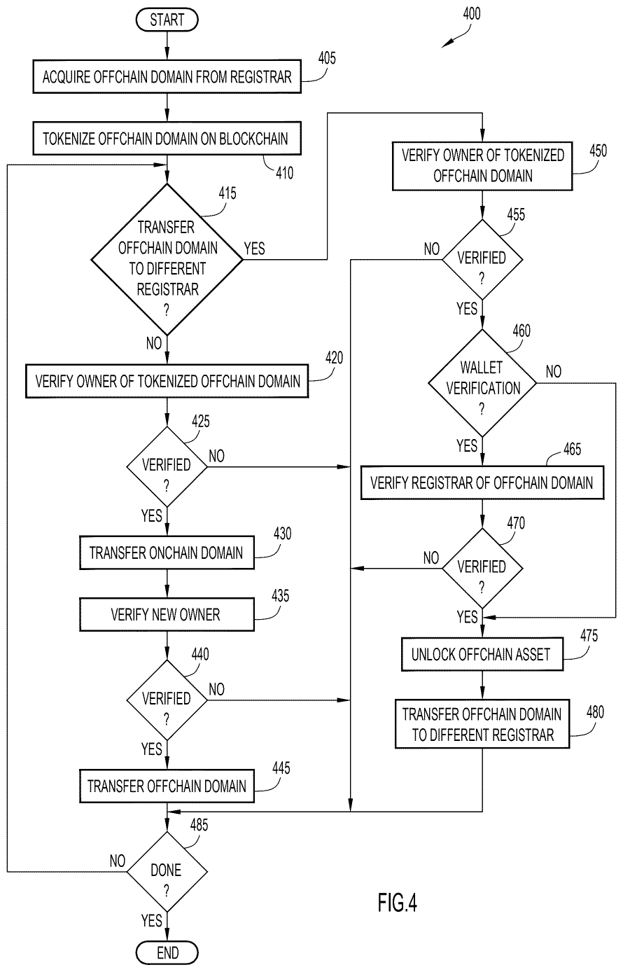

A method 400 of transferring an offchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 4. By way of example, method 400 is described with respect to an onchain asset including a Web3 or blockchain domain or domain name (e.g., represented by a non-fungible token (NFT)) and an offchain asset including a Web2, ICANN, or Domain Name Service (DNS) domain or domain name. However, any onchain and offchain assets may be used in substantially the same manner described below. Further, method 400 is described with respect to a registrar, but any managing entity may be used for transferring the offchain asset in substantially the same manner described below. A managing entity may include any entity controlling (e.g., registering, minting, tokenizing, managing, setting, updating, creating, maintaining, etc.) any operations, information, and/or aspects (e.g., states, properties, transfers, acquisitions, ownership, etc.) for an offchain and/or onchain asset (e.g., registrar, registry, custodian, user, domain owner, etc.).

Initially, management module 116 acquires an offchain domain (e.g., Web2 domain or domain name, ICANN domain or domain name, Domain Name System (DNS) domain or domain name, etc.) from a registrar or other managing entity at operation 405 in substantially the same manner described above (FIG. 3). Management module 116 tokenizes the offchain domain on a blockchain at operation 410 in substantially the same manner described above (FIG. 3). The tokenization may include creating (minting) or publishing a non-fungible token (NFT) representing the offchain domain on the blockchain, and/or transferring an NFT for the offchain domain from a current owner to the user (e.g., places the onchain domain in a user wallet account). A user may include, or be associated with, any type of entity (e.g., individual, company, organization, registrar, etc.). Transfer of an onchain or offchain asset may include any action or transaction that provides ownership or other rights, registration, and/or any other interest in the onchain or offchain asset. Further, acquiring or obtaining an onchain or offchain asset may include obtaining ownership or other rights, registration, and/or any other interest in the onchain or offchain asset. Management module 116 may provide a user interface to enable management of onchain and offchain assets (FIGS. 7 and 8). Alternatively, an application programming interface (API) may be used by other entities (e.g., other systems, devices, applications, managing entities, etc.) to communicate with management module 116 for managing (e.g., creating, acquiring, tokenizing, etc.) onchain and offchain assets.

A user with ownership or other rights to an onchain domain may desire to transfer a corresponding offchain domain to a different user of a same registrar or to a different registrar (e.g., transfer the offchain domain to their account at a different registrar, transfer the offchain domain to another user that uses a different registrar, etc.). When the user desires to transfer a corresponding offchain domain to a different user of a same registrar as determined at operation 415, the user is verified at operation 420. For example, the user may sign a message with a same wallet account containing the onchain domain (or tokenized offchain domain) to confirm acquisition of the onchain domain by the user. By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by the user. A response may be provided to management module 116 (e.g., from the add-on or plug-in of interface module 122) indicating a result of the decryption of the signed message.

When the user is verified as determined at operation 425, the onchain domain is transferred to the new user or owner at operation 430. The domain owner is changed onchain, but the associated registrar (e.g., onchain custodian, etc.) remains unchanged since the registrar remains the same. For example, management module 116 (e.g., via blockchain related application 160, corresponding smart contract 146, and/or decentralized application (dApp) 148) transfers the onchain asset from a current owner to the new user (e.g., places the onchain asset in a user wallet account). The acquisition of the onchain version may be performed based on any required preferences. This may be accomplished by management module 116 (e.g., via blockchain related application 160, corresponding smart contract 146, and/or decentralized application (dApp) 148) providing a transaction to the blockchain indicating acquisition of the onchain version (or NFT) by the new user. In addition, various information for the onchain version (e.g., user information, asset information, wallet information, information for a managing entity of the onchain and/or offchain asset, etc.) may be stored onchain and/or in offchain storage (e.g., database system 118, etc.).

The new user can prove ownership of the onchain representation to the registrar offchain system (e.g., registration system 130, etc.) to take full ownership of the offchain version, including setting the required contact information (e.g., as required by ICANN, etc.). For example, the new user may sign a message with a same wallet account containing the onchain domain (or tokenized offchain domain) to confirm acquisition of the onchain domain by the new user at operation 435 in substantially the same manner described above. When the new user is verified as determined at operation 440, the offchain domain is transferred to the new user at operation 445. For example, management module 116 (e.g., via registration module 132 and registration system 130) may set or update an ownership record of the offchain domain. By way of example, DNS records for the offchain domain may be modified to indicate a new interest or ownership by the new user. Management module 116 may present a user interface on a client system 114 to obtain information (e.g., contact and/or other information, etc.) for updating the records from the new user. The information is provided to registration system 130 for updating records of the offchain domain.

From the time the onchain asset information changes to reflect the new user until the registrar has the domain owner contact information, the new user can freeze changes to DNS records and/or disable DNS resolution of the offchain domain.

When the registrars are to change, the user accesses the custodial code from the current registrar to initiate the change of registrar directly onchain. The custodial code is verifiable onchain, while a destination registrar account is verifiable as a valid registrar in the system.

Alternatively, a new registrar can initiate the change of registrar by being provided with the custodial code by the user from the former registrar. This enables additional process and verification by the new registrar, and allows the new registrar to handle the onchain complexity on behalf of the user. The new registrar may need to process the request within a time window (e.g., set by ICANN, etc.).

The domain registrar is also changed onchain. The registration within the new registrar may be finalized in various manners. For example, the former and new registrars are able to verify their involvement based on onchain activity and can facilitate a seamless transfer of data (e.g., the domain owner may enable an option through the former registrar offchain system (e.g., to allow for transfer of contact information during domain transfers, etc.)). Further, the domain owner may manually enter the new registrar offchain system, verify onchain ownership (e.g., via wallet signature in substantially the same manner described above, etc.), and provide contact or other information (e.g., as required by ICANN, etc.). The new registrar should prevent any DNS changes until receipt of the domain owner contact information.

The offchain registrar should also be changed for correspondence with the onchain registrar. The new registrar inherits all of the capabilities of the onchain custodian to be able to handle compliance (e.g., ICANN compliance, etc.) as the registrar.

For example, when the user desires to change registrars as determined at operation 415, the user is verified at operation 450. By way of example, the user may sign a message with a same wallet account containing the onchain domain (or tokenized offchain domain) to confirm acquisition of the onchain domain by the user. By way of example, signing of the message in a crypto wallet account (e.g., custodied, self-custody, etc.) generates a digital signature of the message based on the private key of the wallet account. The signed message or digital signature is decrypted for verification (e.g., by an add-on or plug-in of interface module 122 of client system 114) based on a public key (e.g., blockchain address, etc.) corresponding to the wallet account. Since the private key is unique to the wallet account, successful decryption of the message with the corresponding public key verifies the message was sent by the user. A response may be provided to management module 116 (e.g., from the add-on or plug-in of interface module 122) indicating a result of the decryption of the signed message.

Transfer of the offchain domain to a different registrar requires unlocking of the offchain domain by the current registrar. The unlocking or authorization permits access and modification of the records of the offchain domain to enable the transfer. Accordingly, when the user is verified as determined at operation 455, the current registrar may be verified (for unlocking the offchain domain) based on a wallet account. For example, management module 116 (e.g., via smart contract 146, decentralized application (dApp) 148, and/or blockchain related application 160) determines and retrieves contact and/or other information for the current registrar of the offchain domain from the information of the onchain domain. The retrieved information may include wallet account information or other information that may be used to determine a wallet account for the current registrar (e.g., onchain domain name resolvable to a wallet address or account, etc.).

When the current registrar is not associated with a wallet account as determined at operation 460, the offchain domain may be released (or unlocked) at operation 475. For example, management module 116 (e.g., via smart contract 146, decentralized application (dApp) 148, and/or blockchain related application 160) determines and retrieves contact and/or other information for the current registrar of the offchain domain from the information of the onchain domain, and sends a notification to the current registrar (or support team) for the offchain domain (e.g., text message, email, chat, etc.) indicating the transfer. The notification may request that the current registrar unlock (or authorize transfer of) the offchain domain, and the current registrar may respond with a notification indicating the offchain domain has been unlocked. In addition, the management module may send a notification to the user (e.g., text message, email, chat, etc.) indicating that the current registrar has been notified.

Further, the custodian code may be retrieved from the onchain domain name and used as a measure of security to verify the current registrar. In this case, the custodian code is decrypted and compared to a valid custodian code (from a corresponding registry) to verify the current registrar for releasing (or unlocking) the offchain domain name.

Moreover, the custodian code may be used (e.g., by the current registrar, new registrar, etc.) to authorize the current registrar to release (or unlock) the offchain domain for transfer to the new registrar (without obtaining express consent from the user). Management module 116 may provide the custodian code to registration system 130 to release (or unlock) the offchain domain. The custodian code basically provides authority or access for the current registrar to perform the actions.

In addition, the current owner may unlock (or authorize transfer of) the offchain asset (e.g., via registration module 132 and registration system 130 using the custodian code or other verification).

When the current registrar is associated with a wallet account (and a wallet verification is desired based on a configuration or parameter) as determined at operation 460, the current registrar is verified based on a wallet verification at operation 465. For example, a signature from a wallet account associated with a current registrar may be obtained in substantially the same manner described above in order to verify the registrar and release (or unlock) the offchain domain for transfer to the new registrar.

By way of further example, a multi-signature solution may be employed. For example, a conventional or other multi-party computation (MPC) wallet may be employed for the onchain domain to obtain signatures from interested parties (e.g., user, current registrar, etc.). This type of wallet divides a private key of the wallet among the interested parties to increase security. The signatures from the interested parties may be verified to authorize the transfer.

Further, the custodian code may be retrieved from the onchain domain name and used as a measure of security to verify the current registrar (e.g., alone or in any combination with the wallet signatures to form a multi-factor type of verification). In this case, the custodian code is decrypted and compared to a valid custodian code (from a corresponding registry) to verify the current registrar.

Once the registrar is verified as determined at operation 470, the offchain domain is released (or unlocked) from the current registrar for transfer to the new registrar at operation 475. For example, a notification may be sent to the current registrar requesting that the current registrar unlock (or authorize transfer of) the offchain domain in substantially the same manner described above. Further, the custodian code may be used (e.g., by the user, current registrar, new registrar, etc.) to authorize the current registrar to release (or unlock) the offchain domain for transfer to the new registrar in substantially the same manner described above.

Once the offchain domain is unlocked, the offchain domain is transferred to the different registrar at operation 480. The offchain domain may be transferred to the different registrar by management module 116 using any conventional or other techniques (e.g., via registration module 132 of a registration system 130 associated with the different registrar in substantially the same manner described above for acquiring an offchain domain).

In order to maintain correspondence between onchain and offchain versions, management module 116 (e.g., via decentralized application (dApp) 148 and/or blockchain related application 160) may set or update records associated with the onchain asset to indicate new registrar information for the offchain asset in substantially the same manner described above. This may occur prior to, or after, transfer of the offchain asset. A record may be created or modified to include information for the new registrar of the offchain asset (e.g., a name of the new registrar, a wallet address of the new registrar, an onchain or offchain domain name for the new registrar, etc.). The record (or a related record) may include a timestamp and/or an order or transaction record for the acquisition of the offchain asset as proof of ownership. The metadata for the onchain asset may be modified to reflect the new registrar, and a user interface may present visual indicators of the new registrar and/or certifications as described below (FIGS. 7 and 8).

In addition, a custodian code may be generated and used to grant access to the new registrar. The custodian code may include a nonce style random code, and/or a real static code (e.g., a proof of authenticity identifier) encoded by a hash-based message authentication (HMAC) using a unique (off-chain) secret (or key) in substantially the same manner described above.

When the user desires to transfer a corresponding offchain domain to a different user (of a different registrar), the registrar may be changed in substantially the same manner described above (where the offchain domain information reflects the different user). Further, the corresponding onchain domain may be transferred to the new user in substantially the same manner described above.

When the user or registrar are not verified as determined at operations 425, 440, 455, or 470, the above process is repeated from operation 415 until occurrence of a termination event (e.g., power down, disable process, etc.) as determined at operation 485.

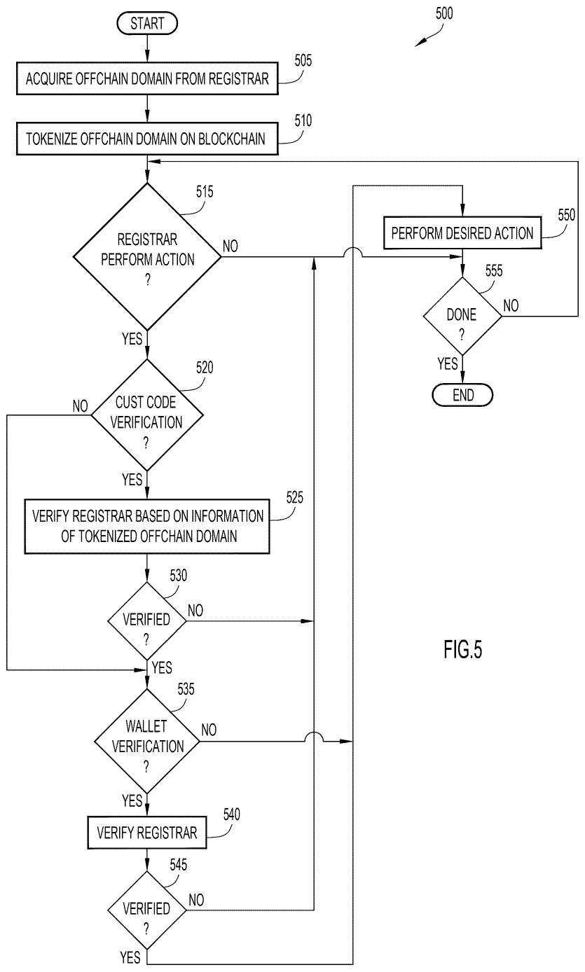

A method 500 of controlling actions for offchain and onchain assets based on assignment of a managing entity within the onchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 5. By way of example, method 500 is described with respect to an onchain asset including a Web3 or blockchain domain or domain name (e.g., represented by a non-fungible token (NFT)) and an offchain asset including a Web2, ICANN, or Domain Name Service (DNS) domain or domain name. However, any onchain and offchain assets may be used in substantially the same manner described below. Further, method 500 is described with respect to a registrar, but any managing entity may perform actions in substantially the same manner described below. A managing entity may include any entity controlling (e.g., registering, minting, tokenizing, managing, setting, updating, creating, maintaining, etc.) any operations, information, and/or aspects (e.g., states, properties, transfers, acquisitions, ownership, etc.) for an offchain and/or onchain asset (e.g., registrar, registry, custodian, user, domain owner, etc.).

Initially, management module 116 acquires an offchain domain (e.g., Web2 domain or domain name, ICANN domain or domain name, Domain Name System (DNS) domain or domain name, etc.) from a registrar or other managing entity at operation 505 in substantially the same manner described above. Management module 116 tokenizes the offchain domain on a blockchain at operation 510 in substantially the same manner described above. The tokenization may include creating or publishing a non-fungible token (NFT) representing the offchain domain on the blockchain, and/or transferring an NFT for the offchain domain from a current owner to the user (e.g., places the onchain domain in a user wallet account). A user may include, or be associated with, any type of entity (e.g., individual, company, organization, registrar or other managing entity, etc.). Transfer of an onchain or offchain asset may include any action or transaction that provides ownership or other rights, registration, and/or any other interest in the onchain or offchain asset. Further, acquiring or obtaining an onchain or offchain asset may include obtaining ownership or other rights, registration, and/or any other interest in the onchain or offchain asset. Management module 116 may provide a user interface to enable management of onchain and offchain assets (FIGS. 7 and 8). Alternatively, an application programming interface (API) may be used by other entities (e.g., other systems, devices, applications, managing entities, etc.) to communicate with management module 116 for managing (e.g., creating, acquiring, tokenizing, etc.) onchain and offchain assets.

A registrar (e.g., custodian of the offchain asset, etc.) may desire to perform an action on the offchain and/or onchain domain without the explicit consent of the owner. The actions may include: performing a takedown request (e.g., render the onchain and/or offchain asset inactive, etc.); register/mint/renew an offchain and/or onchain asset with a custodian code (e.g., used for proof of custodianship) and/or adjust an expiration date; change status of the offchain and/or onchain assets; set a registrar as a custodian of the offchain and onchain assets when the assets are in custody of another custodian, where a new custodian code is established; and/or set another registrar as the custodian of the offchain and onchain assets when the assets are in custody of the registrar. The actions may require the custodian code and/or wallet verification in order to enable the registrar to perform the actions (e.g., without explicit consent of the user).

When the registrar desires to perform an action as determined at operation 515 (e.g., the action may be indicated from a user interface, etc.), a requirement for a custodian code to perform the action is determined. When a custodian code is required as determined at operation 520 (e.g., indicated by registration system 130, a configuration or parameter, etc.), a custodian code of the registrar is verified at operation 525. For example, management module 116 (e.g., via smart contract 146, decentralized application (dApp) 148, and/or blockchain related application 160) determines and retrieves the custodian code and/or other information for the current registrar of the offchain domain from the information of the onchain domain. The custodian code is decrypted and compared to a valid custodian code (from a corresponding registry) to verify the current registrar for performing the desired action.

In addition, a wallet verification of the registrar may be performed. For example, management module 116 (e.g., via smart contract 146, decentralized application (dApp) 148, and/or blockchain related application 160) determines and retrieves contact and/or other information for the current registrar of the offchain domain from the information of the onchain domain. The retrieved information may include wallet account information or other information that may be used to determine a wallet account for the current registrar (e.g., onchain domain name resolvable to a wallet address or account, etc.).

When the registrar is associated with a wallet account (and a wallet verification is desired based on a configuration or parameter) as determined at operation 535, the registrar is verified based on a wallet verification at operation 540. For example, a signature from a wallet account associated with the registrar may be obtained in substantially the same manner described above. By way of further example, a multi-signature solution may be employed. For example, a conventional or other multi-party computation (MPC) wallet may be employed for the onchain asset to obtain signatures from interested parties (e.g., user, current registrar, etc.) in substantially the same manner described above.

When the registrar is verified as determined at operations 530 and/or 545, the action for the offchain and/or onchain asset is performed at operation 550 (e.g., via management module 116, etc.). For example, the action may include performing a takedown request (e.g., render the onchain and/or offchain asset inactive, etc.). This action may be initiated by the managing entity in response to determination of occurrence of certain conditions (e.g., expiration of a domain, improper content, violation of rules, etc.). The takedown or deactivation of an onchain domain may be accomplished in various manners, and includes removing control (or transferring ownership) of the onchain domain from a current user/owner and/or disabling (or preventing access to) any aspect of an onchain domain (e.g., domain name, network resources, web site, service, content, control, etc.). A domain smart contract is preferably configured, or may be configurable (e.g., by a user or other entity via an onchain or other record or parameter, etc.), to deactivate an onchain domain in a particular manner.

For example, a domain smart contract may permanently deactivate (or burn) an onchain domain by posting a transaction on a corresponding blockchain of the decentralized domain that transfers the decentralized domain to a special wallet account or address. The private key of the wallet may be unknown or kept secret to prevent access, changes, and/or transfer of the onchain domain, thereby rendering the deactivation permanent (or irreversible).

The onchain domain may be transferred to a new owner in order to deactivate the onchain domain. In this case, the domain smart contract posts a transaction to the corresponding blockchain temporarily storing the onchain domain in a holding wallet account or address to remove control from the current user and enable the onchain domain to be offered for sale or transfer (e.g., in an online marketplace, via blockchain related application 160, etc.). Once a new user is identified, the domain smart contract transfers the onchain domain to the new user. This may be accomplished by the domain smart contract posting a transaction to a corresponding blockchain transferring ownership of the onchain domain to the new user (e.g., transferring the onchain domain to a wallet account or address of the new user). The domain smart contract may be informed of the new user via an application programming interface (API) utilized by the online marketplace or blockchain related application 160.

The onchain domain may be transferred to a monitored vault (or wallet account or address) until a set of release requirements are satisfied. In this case, the domain smart contract posts a transaction to a corresponding blockchain transferring the onchain domain to the vault (or corresponding wallet account or address). The domain smart contract may monitor the onchain domain for satisfaction of the release requirements (e.g., a decision from appealing the deactivation, a time period, etc.). When the release requirements are satisfied, the domain smart contract releases the onchain domain from the vault and transfers the onchain domain to the original or another user. This may be accomplished by the domain smart contract posting a transaction to a corresponding blockchain transferring the onchain domain to the wallet account or address of the original or other user.

The onchain domain may be effectively (or indirectly) deactivated by preventing access or functionality of the onchain domain. For example, the domain smart contract creates or modifies a record on the corresponding blockchain for the onchain domain to indicate the onchain domain has been marked for takedown or deactivation.

In addition, other records associated with the onchain domain (e.g., onchain, offchain, etc.) may be disabled (e.g., unset, made unavailable, etc.) to indicate deactivation or takedown of the onchain domain. Further, metadata of the onchain domain (e.g., onchain or offchain) may be modified. The metadata may specify storage locations (e.g., onchain or offchain) of various items (e.g., images, etc.). The metadata may be modified to specify a location providing an indication of deactivation of the onchain domain (e.g., adding a property, overriding a location for an image or other item indicated in the metadata, etc.). The domain smart contact may modify the onchain records or metadata to deactivate the onchain domain. In the case of offchain records or metadata (e.g., in offchain storage system 118, etc.), the domain smart contract may provide an indication to a decentralized application 148 (dApp) to modify the offchain records or metadata (e.g., directly or via a blockchain related application 160). When the onchain domain is accessed, the corresponding records or metadata indications are checked. When the records or metadata indications indicate deactivation of the onchain domain (e.g., notification, unavailable, unset, etc.), access to the onchain domain is prevented, thereby effectively (or indirectly) deactivating the onchain domain.

Further, the deactivation may be indicated without modifying (records of) the onchain domain. In this case, the utility or resolution capability of the onchain domain may be disabled. For example, a deactivation smart contract (e.g., separate from the domain smart contract associated with the onchain domain, etc.) may include or have access to a list of onchain domains that are to be deactivated. The list may include any identifying information for an onchain domain (e.g., wallet address or account, owner information, blockchain information, record locations, etc.). When an onchain domain is to be deactivated, the domain smart contract associated with the onchain domain informs or directs the separate deactivation smart contract to add the onchain domain to the list. In this case, when the onchain domain is accessed, the deactivation smart contract is contacted to access and/or provide the list. When the domain smart contract (and/or the deactivation smart contract) determines that the onchain domain appears on the list, access to the onchain domain is prevented (e.g., no record or other domain information is returned), thereby effectively deactivating the onchain domain.

Moreover, a standalone tracking smart contract (e.g., providing a service, etc.) may be employed for tracking deactivations or takedowns (e.g., maintain a listing of deactivated onchain domains, etc.). When the onchain domain is to be deactivated, the domain smart contract associated with the onchain domain informs or directs the tracking smart contract to add the onchain domain to the list. In this case, when the onchain domain is accessed, the tracking smart contract is invoked to check the list. Record information for the onchain domain may include cryptocurrency address resolutions, Interplanetary File System (IPFS)/website resolutions, and any other free-form data to resolve these items for accessing the onchain domain (e.g., resolve these items to the domain location, content locations, etc.). When the onchain domain appears on the list, no record or other domain information is returned, thereby effectively disabling resolution functionality of (or access to) the onchain domain.

In addition, hosting information may be modified to disable the onchain domain. For example, hosting information may be stored in a record offchain (e.g., in offchain storage system 118, etc.) and indicate a location for a web site associated with the onchain domain (e.g., blockchain or other address for the web site and/or content, etc.). A domain smart contract may inform or direct a decentralized application (dApp) 148 to replace, or modify, an offchain record (e.g., Interplanetary File System (IPFS) record, etc.) including information that points to a web site or other content associated with the onchain domain. The decentralized application (dApp) may access the offchain storage (e.g., either directly or via a blockchain related application 160) to modify the information in the offchain record to include a warning indicating the onchain domain is being taken down, an indicator or address to redirect an access request to a landing page, or a blank value. The landing page may provide a notification (e.g., indicating a reason that an onchain domain was deactivated, etc.) and include a link to an information page (e.g., describing deactivation of onchain domains, etc.).

Partial takedowns may be performed for different networks. For example, a domain name used for Web2 and Web3 may violate rules for Web2, but may satisfy rules for Web3. In this case, the domain (or domain name) may be deactivated for Web2 in a conventional manner, while retaining the domain name for Web3. Further, the domain name may violate rules for Web3, but may satisfy rules for Web2. In this case, the domain (or domain name) may be deactivated in substantially the same manner described above for Web3, while retaining the domain name for Web2.

With respect to an offchain domain, management module 116 may provide a notification (with the custodian code) to registration system 130 to deactivate the offchain domain. This may be accomplished by modifying DNS or other records for the offchain domain.

The action may include registering or minting an onchain domain with a custodian code (e.g., used for proof of custodianship), setting a registrar as a custodian of the offchain and onchain domains when the domains are in custody of another custodian, where a new custodian code is established, or setting another registrar as the custodian of the offchain and onchain domains when the domains are in custody of the registrar. These actions may be accomplished in substantially the same manner described above (e.g., via management module 116, smart contract 146, decentralized application (dApp) 148, and/or blockchain related application 160).

The action may include registering an offchain domain which may be accomplished in substantially the same manner described above (e.g., via management module 116 and registration system 130).

Further, the action may include renewing an offchain and/or onchain asset adjusting an expiration date, or changing a status (e.g., valid/active or invalid/deactivated, etc.) of an offchain and/or onchain asset. Management module 116 (e.g., via smart contract 146, decentralized application (dApp) 148, and/or blockchain related application 160) may perform transactions (e.g., tender payment from stored payment information, etc.) to renew the onchain asset and adjust corresponding attributes of the onchain asset stored on a blockchain or in offchain storage (e.g., expiration date, status, etc.). Management module 116 (e.g., via registration system 130) may similarly perform transactions (e.g., tender payment from stored payment information, etc.) to renew the offchain asset and adjust corresponding attributes of DNS or other records (e.g., expiration date, status, etc.).

When the registrar is not verified as determined at operations 530, 545, or after performance of the action at operation 550, the above process is repeated from operation 515 to perform actions until occurrence of a termination event (e.g., power down, disable process, etc.) as determined at operation 555.

Thus, an embodiment of the present invention provides a managing entity with control and access to perform various actions and mirror changes between offchain and onchain versions of an asset to maintain correspondence.

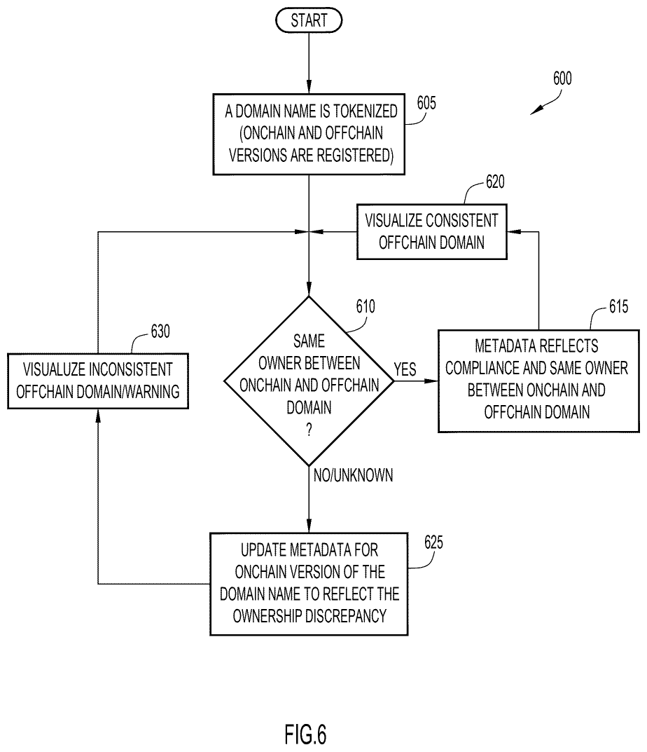

A method 600 for monitoring and visualizing consistency between an offchain asset and a corresponding onchain asset (e.g., via management module 116, registration module 132, smart contract 146, decentralized application (dApp) 148, blockchain related application 160, server system 110, client system 114, registration system 130, and/or blockchain system 140) according to an embodiment of the present invention is illustrated in FIG. 6. By way of example, method 600 is described with respect to an onchain asset including a Web3 or blockchain domain or domain name (e.g., represented by a non-fungible token (NFT)) and an offchain asset including a Web2, ICANN, or Domain Name Service (DNS) domain or domain name. However, any onchain and offchain assets may be used in substantially the same manner described below.

Initially, management module 116 acquires an offchain domain (e.g., Web2 domain or domain name, ICANN domain or domain name, Domain Name System (DNS) domain or domain name, etc.) from a registrar or other managing entity in substantially the same manner described above (FIG. 3). Management module 116 tokenizes the offchain domain on a blockchain at operation 605 in substantially the same manner described above (FIG. 3). The tokenization may include creating (minting) or publishing a non-fungible token (NFT) representing the offchain domain on the blockchain, and/or transferring an NFT for the offchain domain from a current owner to the user (e.g., places the onchain domain in a user wallet account). A user may include, or be associated with, any type of entity (e.g., individual, company, organization, registrar, etc.). Transfer of an onchain or offchain asset may include any action or transaction that provides ownership or other rights, registration, and/or any other interest in the onchain or offchain asset. Further, acquiring or obtaining an onchain or offchain asset may include obtaining ownership or other rights, registration, and/or any other interest in the onchain or offchain asset.

Management module 116 may provide a user interface to enable management of onchain and offchain assets (FIGS. 7 and 8). Alternatively, an application programming interface (API) may be used by other entities (e.g., other systems, devices, applications, managing entities, etc.) to communicate with management module 116 for managing (e.g., creating, acquiring, tokenizing, etc.) onchain and offchain assets.

Management module 116 (e.g., via blockchain related application 160, smart contract 146, decentralized application 148, etc.) determines consistency between the offchain and onchain versions. Consistency between the offchain and onchain assets may indicate whether or not the offchain and onchain assets are consistent or inconsistent with respect to each other. The consistency may be based on any quantity of any attributes (e.g., operational, compliance, property, etc.) of the offchain and onchain assets. For example, offchain and onchain assets may be considered consistent when attributes are the same or the offchain and/or onchain asset are compliant, such as when the ownership or other rights in the offchain and onchain assets are the same, the same entities own or have other rights in the offchain and onchain assets, the offchain and/or onchain asset comply with requirements, and/or the offchain and/or onchain asset are enabled. By way of further example, the offchain and onchain assets may be considered inconsistent when a discrepancy exists (e.g., attributes are different or the offchain and/or onchain asset are non-compliant), such as a difference in ownership or other rights in the offchain and onchain assets, a difference in entities owning or having other rights in the offchain and onchain assets, the offchain and/or onchain asset fail to comply with requirements, the offchain and/or onchain asset are disabled, and/or incomplete, old, and/or incorrect contact or other information for the offchain and/or onchain asset.

The management module may poll records of the offchain and onchain versions (e.g., DNS records, public database, metadata, etc.) to determine or detect occurrence of one or more events and consistency between the offchain and onchain versions (e.g., change in registrar or ownership, deactivation or expiration of an asset, non-compliance, transfer of an asset, etc.). The polling may be performed continuously, periodically, on-demand, or at any desired times. Alternatively, the management module may be aware or notified of a change or other event (e.g., change in registrar or ownership, deactivation or expiration of an asset, non-compliance, transfer of an asset, etc.) to determine or detect occurrence of the event. For example, the management module may be aware or notified of the events or actions described above for FIGS. 4 and 5.

When the onchain and offchain domains are consistent (e.g., have the same owner, are compliant with requirements, etc.) as determined at operation 610, the metadata of the onchain equivalent is updated to indicate that the offchain domain is consistent (e.g., the onchain and offchain domains reflect a same owner, compliance requirements are satisfied, etc.) at operation 615. For example, the offchain version of the domain name may be updated to reflect new ownership per guidelines (e.g., setting contact information for ICANN guidelines, etc.) to be in compliance. The consistency between the offchain and onchain versions is visualized on a user interface (FIGS. 7 and 8) at operation 620. For example, a visual object representing the onchain domain on a user interface may be altered to indicate the offchain and onchain versions are consistent (e.g., color-coded green, a default background image, an icon or checkmark, a metadata description indicating that the offchain domain is consistent, etc.). The visualization may include any visual object, effect, and/or symbol to indicate the offchain and onchain domains are consistent (e.g., any symbol, bold, underline, flash, font, size, color-coding, shading, border, etc.).

By way of example, the visualization may alter an appearance of a visual object on a user interface representing the onchain version by applying a visual effect (e.g., any symbol, bold, underline, flash, font, size, color-coding, shading, border, etc.) to indicate the offchain and onchain versions are consistent. A graphic layer may be generated with the visual effect and overlayed with the visual object on the user interface to alter the appearance.

When a discrepancy arises between the offchain and onchain versions of the domain name (e.g., change of ownership, change of registrar, non-compliance, deactivation or expiration, etc.) as determined at operation 610, the metadata of the onchain equivalent is updated to indicate the offchain and onchain domains are inconsistent (e.g., the onchain and offchain domains reflect a different owner, compliance requirements are not satisfied, etc.) at operation 625. The inconsistency is visualized on a user interface (FIGS. 7 and 8) at operation 630. For example, a visual object representing the onchain domain on a user interface may be altered to indicate the inconsistency (e.g., color-coded orange or red, a default background image, an icon or symbol (e.g., red ‘X’, etc.), metadata description indicating that the offchain domain is non-compliant, etc.). The visualization may include any visual object, effect, and/or symbol to indicate the inconsistency (e.g., any symbol, bold, underline, flash, font, size, color-coding, shading, border, etc.).

By way of example, the visualization may alter an appearance of a visual object on a user interface representing the onchain version by applying a visual effect (e.g., any symbol, bold, underline, flash, font, size, color-coding, shading, border, etc.) to indicate the offchain and onchain versions are inconsistent. A graphic layer may be generated with the visual effect and overlayed with the visual object on the user interface to alter the appearance.

When the consistency between the offchain and onchain domains may not be able to be ascertained (e.g., information for the offchain domain may not be accessible, etc.) as determined at operation 610, the metadata of the onchain equivalent is updated at operation 625 to indicate a warning that the offchain and onchain domains cannot be verified and may be inconsistent. This may be visualized on a user interface (FIGS. 7 and 8) at operation 630. For example, a visual object representing the onchain domain on a user interface may be altered to indicate the warning (e.g., color-coded yellow, a default background image, an icon or symbol (e.g., ‘?’, etc.), metadata description indicating the warning, etc.). The visualization may include any visual object, effect, and/or symbol to indicate the warning (e.g., any symbol, bold, underline, flash, font, size, color-coding, shading, border, etc.).

By way of example, the visualization may alter an appearance of a visual object on a user interface representing the onchain version by applying a visual effect (e.g., any symbol, bold, underline, flash, font, size, color-coding, shading, border, etc.) to indicate the warning. A graphic layer may be generated with the visual effect and overlayed with the visual object on the user interface to alter the appearance. Thus, various layers may be overlayed with visual objects representing onchain domains on the user interface to indicate consistency with corresponding offchain domains and the warning.

Once the consistency (consistent or inconsistent) or warning is visualized at operation 620 or 630, the above process is repeated to monitor the offchain and onchain versions and visualize the corresponding consistency (consistent or inconsistent) or warning in substantially the same manner described above.

An example graphical user interface indicating a domain with corresponding registrar and consistency information according to an embodiment of the present invention is illustrated in FIG. 7. Initially, a user may obtain an offchain asset and a corresponding onchain or tokenized asset in substantially the same manners described above. By way of example, the offchain asset may include an offchain domain name (e.g., Web2 domain name, ICANN domain name, Domain Name System (DNS) domain name, etc.) and the corresponding onchain asset may include a tokenized version of the offchain domain name.

User interface 700 may be presented to a user on a client system 114 (e.g., via interface module 122, etc.). Management module 116 may perform a look-up (e.g., via blockchain system 140) on a blockchain of the tokenized domain name to identify a desired onchain domain name for presentation.

Management module 116 provides the identified onchain (or tokenized) asset on user interface 700 with corresponding information. By way of example, user interface 700 includes a visual domain object 710, a description area 720, an aspects area 730, and an activity area 750. Visual domain object 710 provides an icon or image for the identified onchain domain (e.g., DOMAIN NAME as viewed in FIG. 7). The visual domain object may be modified to indicate consistency (consistent or inconsistent) with the corresponding offchain domain or a warning in substantially the same manner described above. The visualization may include any visual object, effect, and/or symbol to indicate consistency or inconsistency (e.g., any symbol, bold, underline, flash, font, size, color-coding, shading, border, etc.).

Description area 720 provides a description for the onchain domain. Aspects area 730 provides various aspects or properties of the onchain domain including a registrar 740 of the onchain and/or offchain versions (e.g., REG as viewed in FIG. 7) and consistency information for the corresponding offchain domain (e.g., compliant/non-compliant, warning, reason for discrepancy, such as different owner, failing to satisfy compliance requirements, etc.). Activity area 750 provides various information for the onchain domain, including the name of the onchain domain, owner of the onchain domain, pricing of the onchain domain over time, and listings and offers for the onchain domain. The information presented in user interface 700 for the onchain domain may be obtained by searching the blockchain and/or offchain storage.

An example graphical user interface 800 presenting domains with corresponding certifications, registrars, and visualizations indicating consistency according to an embodiment of the present invention is illustrated in FIG. 8. Initially, a user may obtain an offchain asset and a corresponding onchain or tokenized asset in substantially the same manners described above. By way of example, the offchain asset may include an offchain domain name (e.g., Web2 domain name, ICANN domain name, Domain Name System (DNS) domain name, etc.) and the corresponding onchain asset may include a tokenized version of the offchain domain name. In addition, the user may obtain an onchain domain corresponding to the offchain domain in substantially the same manner described above.

User interface 800 may be presented to a user on a client system 114 (e.g., via interface module 122, etc.). Management module 116 may perform a look-up (e.g., via blockchain system 140) on a blockchain to identify onchain versions of the corresponding offchain domain of the user and registrar and certification information.

Management module 116 provides the identified onchain assets on user interface 800 with corresponding visual indicators for the registrar, certification or accreditation, and consistency. By way of example, user interface 800 may present visual domain objects 810 and 830. Visual domain object 810 is associated with a domain 816 (e.g., DOMAIN NAME1 as viewed in FIG. 8) representing the corresponding onchain domain (e.g., Web3) for the offchain domain (e.g., Web2). Visual domain object 810 includes a registrar visual indicator 812 indicating a registrar for the onchain version (e.g. REG1 as viewed in FIG. 8).

Visual domain object 830 is associated with a domain 836 (e.g., DOMAIN NAME2 as viewed in FIG. 8) representing the onchain (or tokenized) version of the offchain domain. Visual domain object 830 includes registrar visual indicator 812 indicating a registrar for the tokenized version (e.g. REG1 as viewed in FIG. 8). In the case of compliance of the corresponding offchain domain, metadata of the tokenized domain reflects the compliance through a certification visual indicator 814 indicating an accreditation or certification (e.g., ICANN, etc.) for the offchain registrar (e.g., ACC as viewed in FIG. 8). In addition, the appearance of visual domain object 830 may be altered in substantially the same manner described above to indicate consistency (consistent or inconsistent) with the offchain domain. For example, a green colored background may be provided to indicate the offchain domain is consistent with the onchain domain. However, the visualization may include any visual object, effect, and/or symbol to indicate consistency (consistent or inconsistent) with the offchain domain (e.g., any symbol, bold, underline, flash, font, size, color-coding, shading, border, etc.).

The user may obtain a tokenized version of another offchain domain from a marketplace or other network site. The system recognizes a discrepancy or change in ownership and reflects within metadata of the tokenized version that there may be a disconnect or inconsistency between ownership of the onchain and offchain version. Accordingly, a visual domain object 850 may be presented on user interface that is associated with a domain 856 (e.g., DOMAIN NAME3 as viewed in FIG. 8) representing the tokenized version of the other offchain domain. Visual domain object 850 includes registrar visual indicator 838 indicating a registrar for the onchain version (e.g. REG2 as viewed in FIG. 8), and a certification visual indicator 814 indicating an accreditation or certification (e.g., ICANN, etc.) for the registrar (e.g., ACC as viewed in FIG. 8).

In order to indicate a discrepancy with the offchain domain, the appearance of visual domain object 850 may be altered in substantially the same manner described above. For example, an icon 860 (e.g., a caution icon, etc.) may be presented, a background color of orange for visual domain object 850 may be provided, and/or textual descriptions of the discrepancy may be shown. However, the visualization may include any visual object, effect, and/or symbol to indicate discrepancy (consistency or consistency) with the offchain domain (e.g., any symbol, bold, underline, flash, font, size, color-coding, shading, border, etc.).

Once visual domain object 850 is changed, metadata of the tokenized version is adjusted. However, before the versions are aligned, any users on a marketplace can immediately view that the offeror of the domain name may not have the rights to transfer both the onchain and offchain version until the versions are consistent within the system as described above.

The registrar, certification, and consistency information provide valuable information to users for performing various actions (e.g., transfer, acquire, etc.) with respect to the domains. For example, a domain with different registrars for onchain and offchain versions, an unknown registrar, and/or no or unknown accreditation, may indicate issues with a chain of ownership or registration for the domain. Further, the visual domain objects may be associated with any visual effects, characters, and/or symbols to indicate a status (e.g., bold, underline, size, color, asterisks, exclamation points, text, etc.). For example, these effects may be used for the visual domain objects to indicate the situations described above (e.g., to indicate a status of different registrars or different ownership of the onchain and offchain versions, to indicate a status of accredited and non-accredited registrars, etc.).

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.).

Further, present invention embodiments provide enhanced security for onchain and offchain assets by maintaining the onchain and offchain assets together (e.g., common ownership, etc.) to prevent wrongful acquisition of the assets. Moreover, this enables an offchain managing entity to control and perform actions for both the onchain and offchain assets, thereby maintaining correspondence between the assets. This provides control of assets on centralized and decentralized systems to certain entities, thereby avoiding user consent for actions and conserving computing resources. In other words, an offchain entity managing offchain assets may leverage functionality and security of onchain (or blockchain) assets (e.g. signatures and other security features, blockchain identifiers, etc.) to perform actions for, and securely control, offchain and onchain assets.

In addition, present invention embodiments provide enhanced security for transfers of computerized assets. For example, a present invention embodiment may enable or disable actions for assets on centralized and/or decentralized systems based on consistency (or inconsistency) between the onchain and offchain versions to prevent fraudulent actions. By way of example, actions to acquire an asset may be disabled when onchain and/or offchain versions are inconsistent (which may indicate a fraudulent asset). Further, a present invention embodiment may automatically perform actions to rectify an inconsistency (e.g., obtain and provide requested information, update records and/or metadata, perform verification of a new user, owner and/or registrar, enable a disabled domain or asset, transfer an offchain and/or onchain asset, etc.).

It will be appreciated that the embodiments described above and illustrated in the drawings represent only a few of the many ways of implementing embodiments for monitoring and visualizing consistency between offchain and onchain assets. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, smart contracts 146, decentralized applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, smart contracts 146, decentralized applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, and blockchain systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, smart contracts 146, decentralized applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, registrar or other managing entity information, etc.). The database system may be implemented by any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., results of registration, notifications, domain or web site content, onchain and/or offchain asset information, requests for assets, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., blockchain assets, status and/or information of onchain and/or offchain assets, registrations, preferences, etc.).

The present invention embodiments are not limited to the specific tasks or algorithms described above, but may be utilized for visualizing and/or controlling actions based on consistency between any onchain asset and a corresponding offchain asset.

An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an offchain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., wallet address, blockchain asset, blockchain domain or user name, user information, etc.).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name.

A user may include, or be associated with, any type of entity (e.g., individual, company, organization, decentralized autonomous organization (DAO), etc.). A managing entity may include any entity (e.g., registrar, registry, custodian, user, domain owner, etc.) performing and/or controlling any operations (e.g., registering, minting, tokenizing, managing, setting, updating, creating, maintaining, acquiring, transferring, etc.), information, and/or aspects (e.g., states, properties, transfers, acquisitions, ownership, etc.) for an offchain and/or onchain asset. Transfer of an onchain or offchain asset may include any action or transaction that provides ownership or other rights, registration, and/or any other interest in the onchain or offchain asset. Further, an interest may include ownership or other rights, registration, and/or any other stake or share in the onchain or offchain asset. Moreover, acquiring or obtaining an onchain or offchain asset may include obtaining ownership or other rights, registration, and/or any other interest in the onchain or offchain asset.

The onchain asset (and offchain asset) may be obtained via any type of transaction. Any suitable proof of acquisition or ownership may be used to prove acquisition or ownership of an asset in order to acquire a corresponding asset (e.g., examine user wallet, examine Domain Name System (DNS) or other records for offchain assets, wallet or other signatures or authorizations, etc.). Acquisition of an asset may reserve a corresponding asset for any time period, and may prevent acquisition of the corresponding asset by another in any fashion (e.g., prevent or deny registration, ownership, interest, rights, etc.). Any type of indicator may be provided for an asset to indicate the corresponding asset is reserved (e.g., in the records for an offchain or onchain asset, non-fungible token (NFT) or other asset in a user wallet, authorization by the parties to a transfer, etc.).

The information for the managing entity may include any information associated with the managing entity and/or offchain asset (e.g., a name of the registrar or other managing entity, a wallet address of the registrar or other managing entity, an onchain or offchain domain name for the registrar or other managing entity, a timestamp of receipt, reception, and/or expiration of the offchain asset, an order or transaction record for the acquisition of the offchain asset as proof of ownership, etc.). The managing entity information may be stored in various manners (e.g., on the blockchain, in offchain storage, a record associated with, or accessible by, a smart contract, etc.).

The managing entity may be authorized to perform any suitable actions for the offchain and onchain assets (with or without consent of a user having an interest or rights in the assets). For example, the actions may include performing a takedown request (e.g., render the onchain and/or offchain asset inactive, etc.); changing DNS records (e.g. if there was a request to remove malicious website content typically the domain owner as well as the registrar can make those changes); register/mint/renew an offchain and/or onchain asset with a custodian code (e.g., used for proof of custodianship) and/or adjust an expiration date; change status of the offchain and/or onchain assets; set a registrar as a custodian of the offchain and onchain assets when the assets are in custody of another custodian, where a new custodian code is established; set another registrar as the custodian of the offchain and onchain assets when the assets are in custody of the registrar; etc. The user and/or managing entity may be verified in any manner (e.g., custodian code, wallet verification, etc.).

The user interface may include any type of visual or other indicator to indicate a status of an onchain or offchain asset (e.g., whether the corresponding asset has been acquired, registrar or other managing entity, certification or accreditation, etc.). For example, assets may be color coded on the user interface to indicate a status (e.g., a first color may indicate that corresponding onchain and offchain assets have been acquired, while a second color may indicate the corresponding asset has not been acquired, etc.). Further, the assets may be represented by, or associated with, any visual objects (e.g., icon, image, etc.). The assets may be associated with any effects, characters, and/or symbols to indicate a status or attribute (e.g., bold, underline, font size, font color, asterisks, exclamation points, text, etc.). The visual or other indicator, visual effects, characters, and/or symbols may indicate any status or attributes of an asset (e.g., corresponding asset acquired, corresponding asset not acquired, asset valid, asset expired, corresponding asset unlocked/authorized for transfer, asset available for transfer, registrar or other managing entity, certification or accreditation. etc.).

The transfer of the onchain asset may be accomplished via any blockchain or other transaction. For example, a transfer may be accomplished by conducting a transaction on the blockchain to indicate transfer of the onchain asset to a new owner. Further, transfer of the offchain asset may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to transfer of the offchain asset.

Present invention embodiments may be used to enable a managing entity to perform any actions for offchain and/or onchain assets, preferably without consent of a user having an interest or rights in the asset. The assets and corresponding assets may be the same or different types of assets, and may be on the same or different types of systems (e.g., centralized, decentralized, etc.).

Consistency between the offchain and onchain assets may indicate whether or not the offchain and onchain assets are consistent or inconsistent with respect to each other and/or a degree or level of consistency. The consistency may be based on any quantity of any attributes (e.g., operational, compliance, property, etc.) of the offchain and onchain assets. For example, offchain and onchain assets may be considered consistent when attributes are the same or the offchain and/or onchain asset are compliant, such as when the ownership or other rights in the offchain and onchain assets are the same, the same entities own or have other rights in the offchain and onchain assets, the offchain and/or onchain asset comply with requirements, and/or the offchain and/or onchain asset are enabled. By way of further example, the offchain and onchain assets may be considered inconsistent when a discrepancy exists (e.g., attributes are different or the offchain and/or onchain asset are non-compliant), such as a difference in ownership or other rights in the offchain and onchain assets, a difference in entities owning or having other rights in the offchain and onchain assets, the offchain and/or onchain asset fail to comply with requirements, the offchain and/or onchain asset are disabled, and/or incomplete, old, and/or incorrect contact or other information for the offchain and/or onchain asset.

The consistency may be monitored or checked continuously, periodically, on-demand, or at any desired times. Alternatively, notification of a change or other event (e.g., change in registrar or ownership, deactivation of an asset, non-compliance, etc.) may be provided.

The consistency or warning may be visualized or otherwise indicated for the offchain and/or onchain asset in any fashion. The visualization may include any visual object, effect, and/or symbol to indicate consistency (consistent or inconsistent) between the offchain and onchain assets or the warning for unknown consistency (e.g., any symbol, bold, underline, flash, font, size, color-coding, shading, border, etc.). A visual object for an offchain and/or onchain domain may include any conventional or other graphical object (e.g., icon, image, actuator, etc.).

The visualization may be generated in any fashion. For example, the visualization may generate an object representing the onchain or offchain asset with a visual effect (e.g., any symbol, bold, underline, flash, font, size, color-coding, shading, border, etc.) to indicate the consistency or warning. Further, the visualization may apply a visual effect (e.g., any symbol, bold, underline, flash, font, size, color-coding, shading, border, etc.) to an object representing the onchain or offchain asset to indicate the consistency or warning. A graphic layer may be generated (with the visual object and/or visual effect) and overlayed on a user interface. Thus, various layers may be overlayed on the user interface to indicate consistency with corresponding offchain domains and the warning.

Any actions or tasks (e.g., transfer, access to offchain and/or onchain assets or information, disablement or enablement of offchain and/or onchain assets, etc.) may be enabled or disabled for assets on centralized and/or decentralized systems based on consistency (consistent or inconsistent) or unknown consistency between the onchain and offchain versions to prevent fraudulent actions. By way of example, actions to acquire an asset may be disabled when onchain and/or offchain versions are inconsistent or have unknown consistency (which may indicate a fraudulent asset). Further, a present invention embodiment may automatically perform actions to rectify an inconsistency (e.g., obtain and provide requested information, update records and/or metadata, perform verification of a new user, owner and/or registrar, enable a disabled domain or asset, transfer an offchain and/or onchain asset, etc.). In addition, offchain and/or onchain assets may be deactivated when the offchain and onchain domains are inconsistent or have unknown consistency, and may be enabled when they become consistent.

Having described preferred embodiments of a new and improved system, method, and computer program product for monitoring and visualizing consistency between offchain and onchain assets, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of managing assets of a computer environment comprising:
detecting, via at least one processor, occurrence of an event for a first asset of the computer environment on a centralized system, wherein the first asset on the centralized system corresponds to a second asset of the computer environment on a decentralized system;
determining, via the at least one processor, consistency between the first asset and the second asset based on the event; and
visualizing for the second asset on a user interface, via the at least one processor, the consistency between the first asset and the second asset.

2. The method of claim 1, wherein the decentralized system includes a blockchain.

3. The method of claim 2, wherein the first asset includes a centralized domain name and the second asset includes one from a group of a blockchain domain name and a non-fungible token.

4. The method of claim 1, wherein the event includes one or more from a group of a change in ownership of the first asset, expiration of the first asset, a transfer of the first asset, and a change in registry of the first asset.

5. The method of claim 1, wherein the consistency is based on ownership of the first asset and the second asset by a same entity.

6. The method of claim 1, wherein the consistency is based on satisfaction of compliance requirements for the first asset.

7. The method of claim 1, wherein visualizing the consistency comprises:
altering an appearance of a graphical object on the user interface representing the second asset with a visual effect when the first asset and the second asset are consistent; and
altering the appearance of the graphical object on the user interface representing the second asset with a different visual effect when the first asset and the second asset are inconsistent.

8. A computer system for managing assets of a computer environment comprising:
one or more memories; and
at least one processor coupled to the one or more memories, the at least one processor configured to:
detect occurrence of an event for a first asset of the computer environment on a centralized system, wherein the first asset on the centralized system corresponds to a second asset of the computer environment on a decentralized system;
determine consistency between the first asset and the second asset based on the event; and
visualize for the second asset on a user interface the consistency between the first asset and the second asset.

9. The computer system of claim 8, wherein the decentralized system includes a blockchain, and wherein the first asset includes a centralized domain name and the second asset includes one from a group of a blockchain domain name and a non-fungible token.

10. The computer system of claim 8, wherein the event includes one or more from a group of a change in ownership of the first asset, expiration of the first asset, a transfer of the first asset, and a change in registry of the first asset.

11. The computer system of claim 8, wherein the consistency is based on ownership of the first asset and the second asset by a same entity.

12. The computer system of claim 8, wherein the consistency is based on satisfaction of compliance requirements for the first asset.

13. The computer system of claim 8, wherein visualizing the consistency comprises:
altering an appearance of a graphical object on the user interface representing the second asset with a visual effect when the first asset and the second asset are consistent; and
altering the appearance of the graphical object on the user interface representing the second asset with a different visual effect when the first asset and the second asset are inconsistent.

14. A computer program product for managing assets of a computer environment, the computer program product comprising one or more non-transitory computer readable media having instructions stored thereon, the instructions executable by at least one processor to cause the at least one processor to:
detect occurrence of an event for a first asset of the computer environment on a centralized system, wherein the first asset on the centralized system corresponds to a second asset of the computer environment on a decentralized system;
determine consistency between the first asset and the second asset based on the event; and
visualize for the second asset on a user interface the consistency between the first asset and the second asset.

15. The computer program product of claim 14, wherein the decentralized system includes a blockchain.

16. The computer program product of claim 15, wherein the first asset includes a centralized domain name and the second asset includes one from a group of a blockchain domain name and a non-fungible token.

17. The computer program product of claim 14, wherein the event includes one or more from a group of a change in ownership of the first asset, expiration of the first asset, a transfer of the first asset, and a change in registry of the first asset.

18. The computer program product of claim 14, wherein the consistency is based on ownership of the first asset and the second asset by a same entity.

19. The computer program product of claim 14, wherein the consistency is based on satisfaction of compliance requirements for the first asset.

20. The computer program product of claim 14, wherein visualizing the consistency comprises:
altering an appearance of a graphical object on the user interface representing the second asset with a visual effect when the first asset and the second asset are consistent; and
altering the appearance of the graphical object on the user interface representing the second asset with a different visual effect when the first asset and the second asset are inconsistent.
